(19) United States
(12) Patent Application Publication
(10) Pub. No.: US 2002/0140682 A1
(43) Pub. Date: Oct. 3, 2002

(54) Optical drawing tablet

(76) Inventors: Frank T. Brown, Beaverton, OR (US); William C. DeLeeuw, Portland, OR (US); Lenka M. Jelinek, Hillsboro, OR (US); David Koizumi, Portland, OR (US)

Correspondence Address: MARGER JOHNSON & McCOLLOM, P.C., 1030 S.W. Morrison Street, Portland, OR, 97205, US

(21) Appl. No.: 09/823,254

(22) Filed: Mar. 29, 2001

(51) Int. Cl. G09G 5/00

(52) U.S. Cl. 345/173

(57) ABSTRACT

A drawing tablet includes a surface and an imaging sensor. The imaging sensor captures an image from the surface of the drawing tablet. The image may be transmitted to a computer, where the image can be processed: for example, to correct for distortion or to animate a portion of the image.

### FIELD OF THE INVENTION

This invention pertains to drawing tablets, and more particularly to a drawing tablet operable with a computer.

### BACKGROUND OF THE INVENTION

Drawing tablets have been around for quite some time. In the world of computers, graphical artists use drawing tablets to produce graphical works. Other uses for drawing tablets include as alternatives for pointing devices, such as the computer mouse, and as other input means.

To date, drawing tablets have suffered from three significant limitations. The first limitation is the requirement that the user split his focus. Most drawing tablets use specially designed tools for selecting a spot on the drawing tablet. These special tools do not actually draw on the tablet. Thus, to see what he is drawing, the user must look at the monitor to which the drawing tablet is connected. Since the action of moving the pointer on the drawing tablet and the visual input representing the results of that movement are split between two devices, the user must split his focus. Because his focus is split, the results produced are usually less than ideal. A typical user must either spend a great deal of time becoming comfortable with the problem of split focus, or resign himself to poor quality results.

Light pens, used with ancillary hardware, avoid this problem, since the user is drawing directly on top of the image on the monitor. But light pens only work with monitors, which are generally oriented with the screen in the vertical plane. This orientation of the monitor is very awkward for most people to work with: people generally prefer to draw/write on horizontally oriented surfaces. Further, light pens do not leave any ink on the monitor (doing so would leave a mark on the monitor that would affect later use of the monitor).

Another limitation of modem drawing tablets is their possible sources of input. (This limitation also applies to light pens.) Because they are designed to operate with special tools, most modem drawing tablets can only receive input from the special tools. For example, if a user wants to introduce a drawing of an animal into the drawing tablet, generally the user must draw the animal himself.

Another limitation modem drawing tablets experience is occlusion. Even if the drawing tablet is capable of receiving input from random objects placed on the surface, the drawing tablets capture the image from above the surface of the drawing tablet. But if two objects overlap, the portion of the lower object is occluded from capture, and is lost.

The present invention addresses this and other problems associated with the prior art.

### BRIEF DESCRIPTION OF THE DRAWINGS

FIG. 1 shows a drawing tablet according to the embodiment of the invention connected to a computer system.

FIG. 2 shows the monitor of the computer system of FIG. 1 is greater detail.

FIG. 3 shows successive representations of a portion of the drawing tablet of FIG. 1 and the resulting animation on the monitor of the computer system of FIG. 1.

FIG. 4 shows the procedure used by the drawing tablet of FIG. 1 and its associated software to display an image on the monitor of FIG. 2.

FIG. 5 shows the procedure used by the drawing tablet of FIG. 1 to project a light segment and track how closely the light segment was followed by the user.

### DETAILED DESCRIPTION

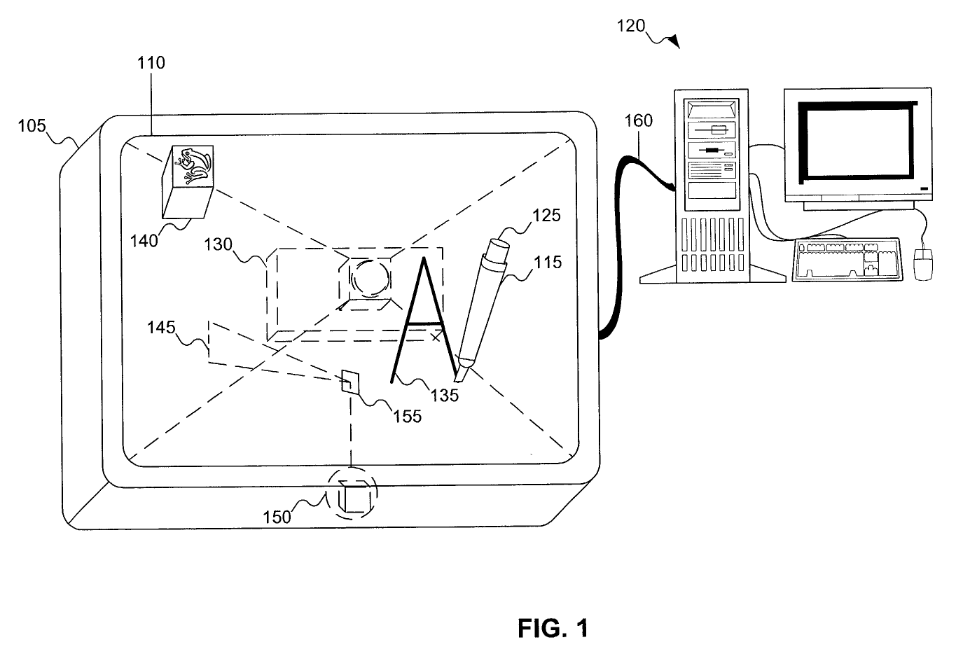

FIG. 1 shows a drawing tablet according to the embodiment of the invention connected to a computer system. In FIG. 1, drawing tablet 105 includes surface 110. Surface 110 is designed to be drawn upon using markers, such as marker 115, that leave removable marks on surface 110. In this way, drawing tablet 105 does not require the user to split his focus between what he is drawing on drawing tablet 105 and what he sees on a computer monitor, such as the computer monitor included in computer system 120. In one embodiment, marker 115 is the only marker provided with drawing tablet 105. In second embodiment, marker 115 is one of several markers provided with drawing tablet 115. In this second embodiment, each marker may be in a different color.

In one embodiment, marker 115 is a dry erase marker, which may be erased from surface 110 of drawing tablet 105, either to correct a mistake or to remove marks no longer desired. Marker 115 is shown with eraser 125 attached to marker 115, but a person skilled in the art will recognize that eraser 125 may be a separate piece (not shown in FIG. 1) included with drawing tablet 105.

Surface 110 of drawing tablet 105 is translucent, which means that light may pass through it. This allows imaging sensor 130 to capture an image from below surface 110 of drawing tablet 105. In one embodiment, imaging sensor is an optical sensor that optically captures the entire image of surface 110 at once. In a second embodiment, imaging sensor can include magnetic sensing, wherein marker 115 and any objects placed on surface 110 of drawing tablet 105 are designed to interact with the magnetic sensor, to locate and identify marker 115 or the object. In a third embodiment, imaging sensor 115 may include radio frequency (RF) or pressure sensing to determine the location of objects drawn on surface 110 of drawing tablet 105. (A person skilled in the art will also recognize other ways imaging sensor 130 may capture an image on surface 110.) Using imaging sensor 130 mounted below surface 110 of drawing tablet 105 avoids two of the limitations of the prior art: no specialized tools are required to draw on drawing tablet 105, and occlusion of the lower image is avoided (if one image on surface 110 is covered by another image, the lower image is properly captured). This is useful, for example, if the user is using his hands above the surface, say to manipulate objects on surface 110 of drawing tablet 105.

Because imaging sensor 130 is used to capture an image on surface 110, the image may include both marks generated by marker 115 (such as letter “A” 135) and objects placed on surface 110 (such as block 140). Block 140 includes on its bottom side a picture of a frog, just as is shown on the top side of block 140. It is the image/symbol of the frog on the bottom side of block 140 that is captured by imaging sensor 130. (As long as the relationship between the pictures on the top and bottom of block 140 is known, it is not necessary for the pictures to be the same.)

In a further embodiment, drawing tablet 105 may project light segments onto surface 110. These projected light segments may be used, for example, to teach a student how to write. To project light segments, such as light segment 145, light source 150 emits a beam of light. This light is reflected using by mirrors, such as mirror 155 to the points on surface 110 at which the light segment is to appear. The angle of mirror 155 is adjusted using servos or galvanometers (not shown in FIG. 1). In this way, light segment 145 can be rotated to any angle and extended or shortened to any length. In yet another embodiment, a more complicated arrangement of light sources, mirrors, and servos or galvanometers may allow for more intricate arrangement of light segments: for example, curved light segments or multiple line segments.

When light segment 145 is used as a teaching tool, a goal of drawing tablet 105 is to track how closely the user follows the line segments in practicing his writing. Software (not shown in FIG. 1) may be used to compare the image captured by imaging sensor 130 with the location of projected light segment 145. If the image shows a line close in position and shape to projected light segment 145, the user may be rewarded: for example, by producing an animation on the computer monitor of computer system 120. A new light segment may then be projected for the user to follow. Alternatively, if the user did not follow projected light segment 145 closely enough, the user may be encouraged to try again.

The signals instructing the production of projected light segment 145 may come from a variety of sources. For example, the instructions may come from computer system 120. Alternatively, drawing tablet 105 may be equipped with memory and circuitry (not shown in FIG. 1) that specifies how projected light segment 145 is to be drawn. In this alternative, the memory stores a number of predefined instructions for drawing particular combinations of projected light segments. The memory may also be upgradeable, and thus may receive new instructions for forming new combinations of projected light segments. Such instructions might come from, for example, computer system 120. A person skilled in the art will recognize other sources for instructing how to produce projected light segment 145.

The luminance of light source 150 may be varied as it draws projected light segment 145. This enables project light segment 145 to include portions that stand out more to the eye. This may make it easier for a user to follow projected light segment 145, when used as a teaching tool.

In one embodiment, drawing tablet 105 communicates with computer system 120 via cable 160. Cable 160 passes images captured by imaging sensor 130, information about projected light segments, and other such information to or from computer system 120. Computer system 120 may then process the captured image and other information: for example, to produce an image on the computer monitor in computer system 120. Alternatively, because imaging sensor 130 may capture a distorted image from surface 110 of drawing tablet 105 (e.g., because imaging sensor 130 is not the same distance from all points on surface 110), computer system 120 may process the image to correct for distortion in the image. A person skilled in the art will recognize other uses for the information provided via cable 160. For example, cable 160 may also transmit line segment instructions from computer system 120 to drawing tablet 105.

As the user updates the image on surface 110 of drawing tablet 105, cable 160 may transmit the updates to computer 120. For example, if the user uses eraser 125 to erase a portion of the image, cable 160 may transmit the updated image to computer system 120. Software in computer system 120 may then correspondingly update the image of the monitor of computer system 120 to reflect the erasure.

Although cable 160 is one way for drawing tablet 105 to communicate with computer system 120, a person skilled in the art will recognize other ways drawing tablet 105 and computer system 120 can communicate. For example, drawing tablet 105 and computer system 105 may include wireless transmitters/receivers for use in communication. Any wireless protocols may be used for communication, including but not limited to radio frequency (RF) transmission, infrared transmission, Bluetooth, and the like.

As the image drawn on surface 110 may change as the user draws, imaging sensor 130 may capture images over time, which are transmitted in turn to computer system 120. Software in computer system 120 may then process the images to update the display in the computer monitor to reflect the changes on surface 110 of drawing tablet 105. Imaging sensor 130 may capture images from surface 110 of drawing tablet 105 at any frame rate: for example, imaging sensor 130 may capture 20 images per second to transmit to computer system 120.

In yet another embodiment, drawing tablet 105 includes an additional light (now shown in FIG. 1) for increasing the contrast of images drawn on surface 110 of drawing tablet 105. This additional light may be positioned over surface 110, or if surface 110 has sufficiently low reflectivity and can light objects placed on surface 110, the additional light may be positioned below surface 110.

In yet another embodiment, a user may place a sheet of translucent paper over surface 110 of drawing tablet 105. The user may then draw on the sheet of paper. Imaging sensor 130 captures the image through the sheet of paper. The user may then remove the sheet of paper from drawing tablet 105 and yet retain the image on the sheet of paper.

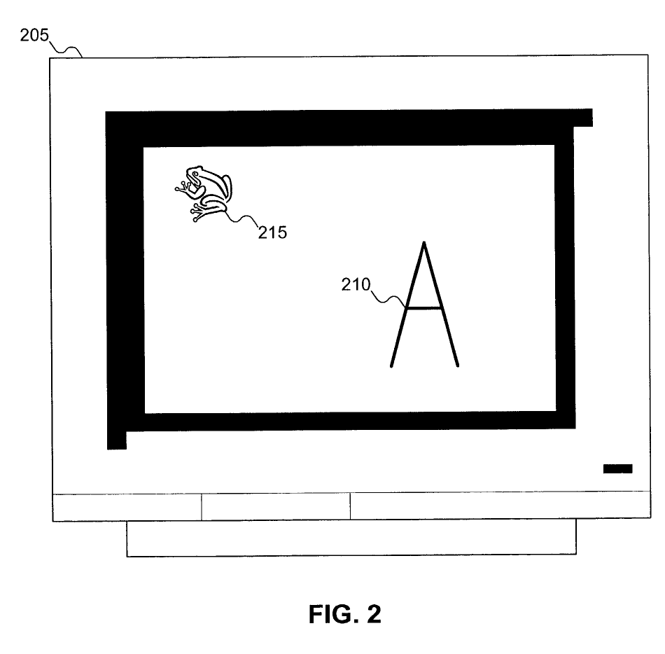

FIG. 2 shows the monitor of the computer system of FIG. 1 is greater detail. In FIG. 2, monitor 205 shows the monitor of computer system 120 in its state corresponding to the state of drawing tablet 105 in FIG. 1. Recall that the user has drawn the letter “A” 135 on surface 110 of drawing tablet 105, and the user has placed block 140 on surface 110 of drawing tablet 105. Imaging sensor 130 may capture this information and transmit it to computer system 120. Software in computer system 120 may then process the image, and display it, as shown on computer monitor 205 of FIG. 2. The letter “A” 210 on computer monitor 205 may be shown in the position on screen corresponding to where the letter “A” 135 was drawn on surface 110 of drawing tablet 105. Similarly, frog 215 may be shown in the position corresponding to where block 140 was placed on surface 110 of drawing tablet 105.

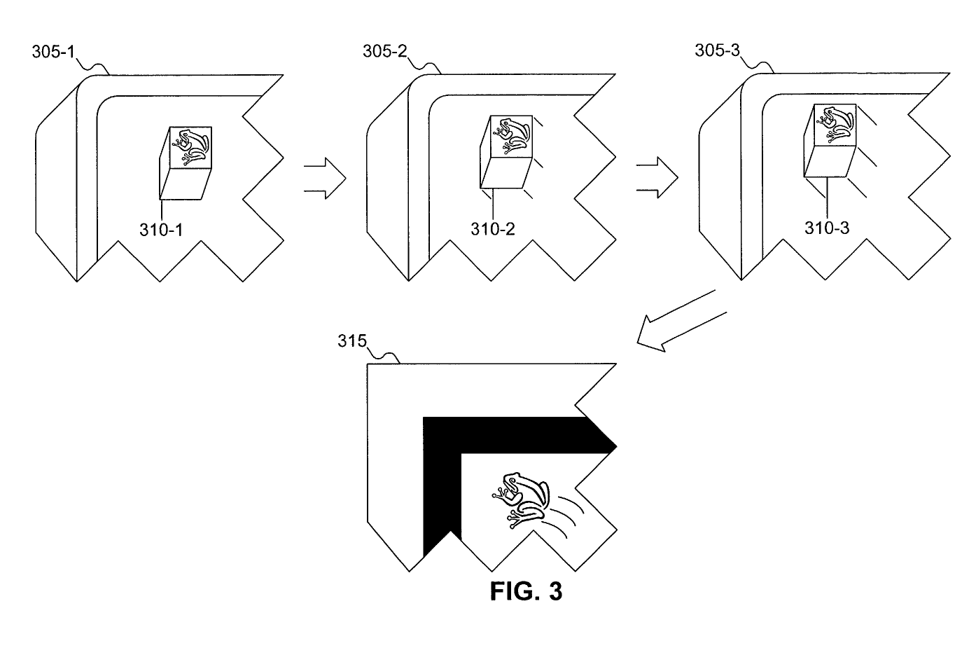

FIG. 3 shows successive representations of a portion of the drawing tablet of FIG. 1 and the resulting animation on the monitor of the computer system of FIG. 1. In FIG. 1, portions 305-1, 305-2, and 305-3 show a corner of the drawing tablet of FIG. 1. In portions 305-1, 305-2, and 305-3, a block with a picture of a frog is incrementally moved from bottom right to top left, as shown by blocks 310-1, 310-2, and 310-3. When the successive images captured by the imaging sensor are transmitted to the computer system, the computer system may recognize the motion is indicative of an animation, and animate the frog, as shown in the portion of monitor 315.

A person skilled in the art will recognize that, although three sequential images are used in FIG. 3 to animate the frog, more or fewer images may be used. For example, the software of the computer system may recognize the block of the frog as a predefined image to be animated, even without the block being moved. In addition, a picture may be animated without the use of a physical object such as blocks 310-1, 310-2, and 310-3. For example, a user may draw an image in multiple locations on the drawing tablet, which the computer system can recognize as representing a sequence of images to playback as an animation.

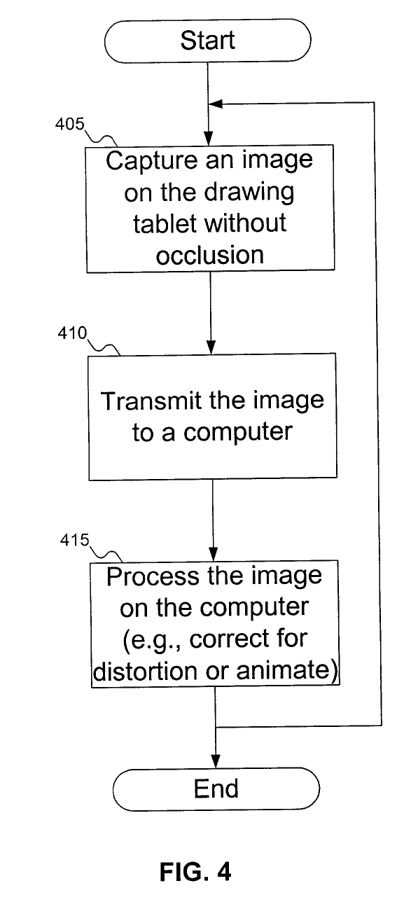

FIG. 4 shows the procedure used by the drawing tablet and its associated software to display an image on the monitor of FIG. 2. In FIG. 4, at block 405 an image is captured from the drawing tablet. At block 410, the image is transmitted to a computer. Finally, at block 415, the image is processed as necessary: for example, to correct for distortion in the imaging sensor, or to animate a portion of the image. The procedure may then start over at block 405 to capture a new image from the surface of the drawing tablet.

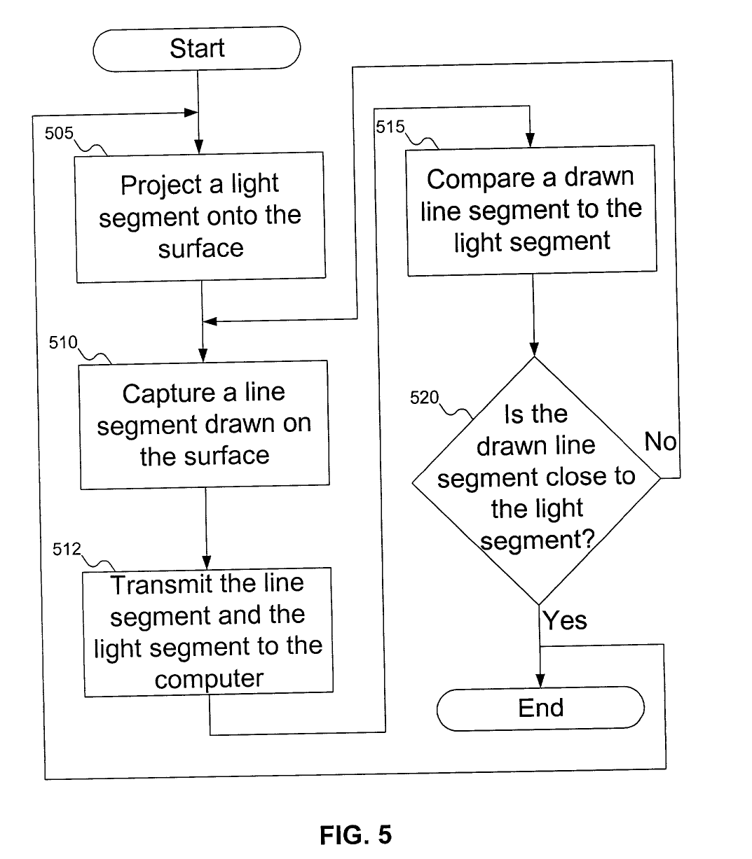

FIG. 5 shows the procedure used by the drawing tablet to project a light segment and track how closely the light segment was followed by the user. In FIG. 5, at block 505 a light segment is projected onto the surface of the drawing tablet. At block 510, a line segment drawn by the user on the surface of the drawing tablet is captured. Typically, this line segment is captured as part of an image of the surface of the drawing tablet, but a person skilled in the art will recognize that the line segment can be captured without sensing the rest of the image. At block 512, the line segment and the light segment are transmitted to the computer for processing. At block 515, the line segment and the light segment are compared to see how closely the line segment was drawn to the light segment. If the line segment is not sufficiently close to the light segment (sufficiently close is a parameter that can be adjusted as desired for the application), then decision point 520 prompts the user to try to draw the line segment again, and the procedure returns to block 510. Otherwise, decision point 520 determines that the procedure is complete (unless a new light segment is to be presented to the user, in which case the procedure may continue at block 505).

The uses of the embodiments of the invention are numerous. To describe but a few, the embodiments of the invention may be used to teach the user how to write. As described above, a light segment may be projected. The imaging sensor may then capture a line segment drawn by the user. If the line segment is drawn closely enough to the light segment, the drawing tablet may then project another light segment to further instruct the user. For example, the letter “A” may be taught using three light segments, for the three lines in the letter.

A second use of the embodiments of the invention may be as a game. For example, the user may place a template of a story with missing words on the drawing tablet. The user may then place objects with pictures over the missing words in the template. After the imaging sensor captures the image of the template and the blocks, the computer system may animate the image where the blocks are placed in the template.

Having illustrated and described the principles of our invention in an embodiment thereof, it should be readily apparent to those skilled in the art that the invention can be modified in arrangement and detail without departing from such principles. We claim all modifications coming within the spirit and scope of the accompanying claims.

We claim:

1. A drawing tablet comprising:
a surface; and
an imaging sensor designed to capture an image on the surface, the imaging sensor designed to capture the image even if the image is occluded.

2. A drawing tablet according to claim 1, wherein:
the surface is translucent; and
the imaging sensor is mounted below the surface.

3. A drawing tablet according to claim 2, the drawing tablet further comprising transmission means designed to transmit the image captured by the imaging sensor to a computer.

4. A drawing tablet according to claim 3, wherein the transmission means includes a cable coupled to the drawing tablet and to the computer.

5. A drawing tablet according to claim 3, wherein the transmission means a wireless transmitter designed to wirelessly transmit the image to the a wireless receiver coupled to the computer.

6. A drawing tablet according to claim 2, the drawing tablet further comprising software in a computer designed to adjust the image to compensate for distortion by the imaging sensor.

7. A drawing tablet according to claim 2, the drawing tablet further comprising software in a computer designed to adjust the image to compensate for a reversed image captured by the imaging sensor.

8. A drawing tablet according to claim 2, the drawing tablet further comprising an erasable pen designed to draw on the surface.

9. A drawing tablet according to claim 8, the drawing tablet further comprising an eraser for erasing marks produced by the erasable pen.

10. A drawing tablet according to claim 8, wherein the image is hand-drawn with the erasable pen.

11. A drawing tablet according to claim 2, wherein the imaging sensor is designed to capture images of physical objects placed on the surface.

12. A drawing tablet according to claim 2, wherein the imaging sensor is designed to capture colors in the image on the surface.

13. A drawing tablet according to claim 2, the drawing tablet further comprising software in a computer designed to animate at least a portion of the image.

14. A drawing tablet according to claim 13, wherein the software is designed to animate the portion of the image based on a movement of a physical object placed on the surface.

15. A drawing tablet according to claim 2, the drawing tablet further comprising light projecting means.

16. A drawing tablet according to claim 15, wherein the light projecting means includes:
a light emitting source; and
mirrors designed to reflect the light; and
galvanometers designed to move the mirrors to steer light emitting from the light emitting source onto the surface.

17. A drawing tablet according to claim 16, wherein the light emitting source is constructed and arranged to vary its luminance.

18. A drawing tablet according to claim 2, the drawing tablet further comprising an additional light source to increase contrast of the image on the surface as captured by the imaging sensor.

19. A method for using a drawing tablet, the method comprising:
capturing an image from the surface of the drawing tablet so that no objects on the surface of the drawing tablet are occluded;
transmitting the captured image to a computer; and
processing the captured image on the computer for display on a monitor.

20. A method according to claim 19, wherein capturing an image includes capturing the image from beneath the surface of the drawing tablet, the drawing tablet including a translucent surface.

21. A method according to claim 20, wherein transmitting the captured image includes wirelessly transmitting the captured image to a computer.

22. A method according to claim 20, wherein processing the captured image includes animating at least a portion of the captured image.

23. A method according to claim 22, wherein animating at least a portion of the captured image includes animating the portion of the captured image based on the contents of the captured image.

24. A method according to claim 23, wherein animating the portion of the captured image includes animating the portion of the captured image based on a change in the contents of the captured image.

25. A method according to claim 20, the method further comprising repeating at intervals the steps of capturing, transmitting, and processing.

26. A method according to claim 25, the method further comprising updating the image on the surface of the drawing tablet.

27. A method according to claim 20, the method further comprising projecting a light onto the drawing tablet.

28. A method according to claim 27, the method further comprising;
capturing a change in the captured image; and
measuring how accurately the change follows the projected light.

29. An article comprising:
a storage medium, said storage medium having stored thereon instructions, that, when executed by a computing device, result in:
receiving an image captured from a surface of a drawing tablet, the image captured in a manner such that mo portion of the surface of the drawing tablet is occluded;
modifying the received image; and
displaying the modified image.

30. An article according to claim 29, wherein receiving an image includes receiving the image captured by an imaging sensor from the surface of the drawing tablet.

31. An article according to claim 29, wherein receiving an image includes receiving an image captured from beneath the surface of the drawing tablet, the surface of the drawing tablet being translucent.

32. An article according to claim 29, wherein modifying the received image includes modifying the received image based on the contents of the image.

33. An article according to claim 29, wherein modifying the received image includes modifying the image based on a change from a prior image.

34. An article according to claim 33, wherein modifying the image based on a change from a prior image includes animating the image based on the change.
